(19) United States
(12) Patent Application Publication
(10) Pub. No.: US 2026/0337315 A1
(43) Pub. Date: Oct. 29, 2026

(54) HYDROCARBON RESIN POLYMER, MANUFACTURING METHOD THEREOF, RESIN COMPOSITION, CURABLE COMPOSITE MATERIAL, CURED RESIN BODY, AND RESIN PRODUCT

(71) Applicant: LCY CHEMICAL CORP., Kaohsiung City (TW)

(72) Inventors: Ka Chun AU-YEUNG, Kaohsiung City (TW); Wei-Liang LEE, Kaohsiung City (TW); Yong-Yun ZHANG, Kaohsiung City (TW); Yi-Hsuan TANG, Kaohsiung City (TW); Tz-Jie JU, Kaohsiung City (TW)

(21) Appl. No.: 19/653,757

(22) Filed: Apr. 21, 2026

Related U.S. Application Data
(60) Provisional application No. 63/792,707, filed on Apr. 22, 2025.

(30) Foreign Application Priority Data
Mar. 30, 2026 (TW) 115112435

(51) Int. Cl. C08F 212/06; C08F 2/06; C08F 4/14; C08F 6/12

(52) U.S. Cl. CPC C08F 212/06; C08F 2/06; C08F 4/14; C08F 6/12

(57) ABSTRACT

A hydrocarbon resin polymer includes a structural unit (A) represented by Chemical Formula (I) and a structural unit (B) derived from a divinyl aromatic compound. In Chemical Formula (I), “*” indicates a bonding site at which the structural unit (A) is connected to another group or unit. A method for manufacturing a hydrocarbon resin polymer is provided. The method includes performing a polymerization process to form a reaction product including the above-mentioned hydrocarbon resin polymer from a mixture. The mixture includes a divinyl aromatic compound and vinyl toluene.

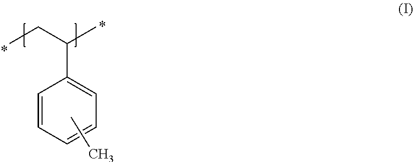

### CROSS REFERENCE TO RELATED APPLICATIONS

This application claims the benefit of U.S. provisional application No. 63/792,707, filed Apr. 22, 2025, and Taiwan patent application No. 115112435, filed Mar. 30, 2026, the entirety of which are incorporated by reference herein.

### TECHNICAL FIELD

The present disclosure relates to a resin polymer, a manufacturing method thereof, a resin composition, a curable composite material, a cured resin body, and a resin product including the same, and, in particular, it relates to a hydrocarbon resin polymer, a manufacturing method thereof, a resin composition, a curable composite material, a cured resin body, and a resin product including the same.

### BACKGROUND

Fifth generation mobile communication technology (5th generation mobile networks, abbreviated as 5G) is the latest generation of mobile communication technology. The 5G mobile communication technology features high-speed transmission, wide connection, and low latency. There are three types of 5G mobile communication technology, depending on which frequency band is used: high-frequency 5G, intermediate-frequency 5G, and low-frequency 5G. High-frequency 5G can provide ultra-high connection rates.

However, during transmission, high-frequency 5G signal transmission and reception can be affected by high-frequency path loss, conductor loss, and dielectric loss. Therefore, it is necessary to develop a material for copper clad laminate (CCL) having low dielectric loss to reduce the dielectric loss of high-frequency 5G during transmission, thereby enhancing the quality of signal transmission and reception.

Copper clad laminate materials for high-frequency or high-speed circuit boards are required not only to have a low dielectric constant and low dielectric loss to ensure good electrical performance, but they may also have to exhibit good thermal properties and thermal stability, such as a higher glass transition temperature (Tg) or a lower coefficient of thermal expansion in the thickness direction (PTEz), so as to withstand high-temperature environments during processing and use while maintaining dimensional stability. In addition, such materials may need to have good adhesion and processability to improve the reliability and production efficiency of multilayer circuit board manufacturing processes. Accordingly, how to develop resin materials capable of improving one or a combination of the above properties has become a technical issue that urgently needs to be addressed in the field of high-frequency and high-speed circuit boards.

### BRIEF SUMMARY

In view of the above issues, the present disclosure provides a hydrocarbon resin polymer having good electrical properties, thermal properties, thermal stability, adhesion, and/or processability, and a method for manufacturing the same. In some embodiments, the electrical properties may include a low dielectric constant and a low dielectric loss factor (Df), and the thermal properties and thermal stability may include a higher glass transition temperature (Tg) and/or a lower coefficient of thermal expansion in the thickness direction (PTEz). The hydrocarbon resin polymer may further have a high peel strength with respect to copper foil, good solubility in commonly used organic solvents, appropriate anti-flow characteristics during a lamination process, and/or the ability to be cured at a lower temperature, thereby reducing process energy consumption and reducing deterioration of dielectric properties caused by thermal oxidation. In some embodiments, the method for manufacturing the hydrocarbon resin polymer of the present disclosure may improve process safety and environmental friendliness. Resin compositions, curable composite materials, cured resin bodies, and resin products including the hydrocarbon resin polymer of the present disclosure may also have one or a combination of the above properties.

An embodiment of the present disclosure provides a hydrocarbon resin polymer including a structural unit (A) represented by Chemical Formula (I) and a structural unit (B) derived from a divinyl aromatic compound. In Chemical Formula (I), “*” indicates a bonding site at which the structural unit (A) is connected to another group or unit.

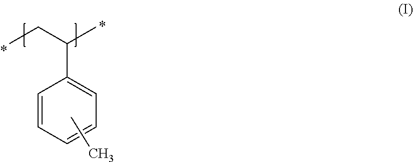

An embodiment of the present disclosure provides a method for manufacturing a hydrocarbon resin polymer, which includes performing a polymerization process to form a reaction product including the above-mentioned hydrocarbon resin polymer from a mixture. The mixture includes a divinyl aromatic compound and vinyl toluene.

An embodiment of the present disclosure provides a resin composition including the above-mentioned hydrocarbon resin polymer.

An embodiment of the present disclosure provides a curable composite material including the above-mentioned hydrocarbon resin polymer.

An embodiment of the present disclosure provides a cured resin body formed from the above-mentioned hydrocarbon resin polymer.

In addition, an embodiment of the present disclosure provides a resin product including the above-mentioned cured resin body.

### BRIEF DESCRIPTION OF THE DRAWINGS

No drawings are provided.

### DETAILED DESCRIPTION

It will be further understood that when “including” and/or “comprising” are used in this specification, they particularly refer to the existence of the described features, integers, steps, operations, elements, components, and/or groups thereof, but do not exclude the existence or addition of one or more other features, integers, steps, operations, elements, components, and/or groups thereof. When the singular forms “a” and “an” are used in this specification, it is intended to include the plural forms as well, unless the context clearly indicates otherwise.

It will be understood that although the terms “first”, “second”, and the like, may be used herein to describe various elements, components, regions, layers and/or portions, these elements, components, regions, layers and/or portions should not be limited by these terms. These terms are only used to distinguish one element, component, region, layer or portion from another element, component, region, layer or portion.

It is to be understood that the terms “about,” “approximately,” and “substantially” as used herein generally indicate within 20% of a given value or range, preferably within 10%, and more preferably within 5%, or within 3%, or within 2%, or within 1%, or within 0.5%. A given quantity herein is an approximate quantity, that is, even in the absence of explicit recitation of “about,” “approximately,” or “substantially,” the meaning of “about,” “approximately,” or “substantially” is still implicitly included. Further, values expressed in the present disclosure may include the stated values and deviation values within a deviation range acceptable to a person having ordinary skill in the art. It is to be understood that the expression “a to b” or “a-b” used herein to express a specific numerical range is defined as “≥a and ≤b.”

Unless defined otherwise, all technical and scientific terms used herein have the same meaning as commonly understood by one of ordinary skill in the art to which this disclosure belongs. It will be understood that these terms, for example, terms defined in commonly used dictionaries, should be interpreted as having meanings consistent with the relevant art and the background or context of the present disclosure, and should not be interpreted in an idealized or overly formal manner, unless specifically defined in the embodiments of the present disclosure. Descriptions that may unnecessarily obscure known functions and structures of the present disclosure will be omitted below.

As used herein, “C₁₋₂₀ alkyl group” refers to a linear, branched, or cyclic aliphatic hydrocarbon monovalent group having 1 to 20 carbon atoms on the main carbon chain. Examples of C₁₋₂₀ alkyl group may include methyl group, ethyl group, propyl group, isobutyl group, sec-butyl group, tert-butyl group, pentyl group, isopentyl group, hexyl group, decyl group, dodecyl group, cyclohexyl group, cyclooctyl group, and cyclododecyl group, but the present disclosure is not limited thereto.

Some embodiments of the present disclosure provide a hydrocarbon resin polymer including a structural unit (A) represented by the following Chemical Formula (I) and a structural unit (B) derived from a divinyl aromatic compound. In Chemical Formula (I), “*” indicates a bonding site at which the structural unit (A) is connected to another group or unit.

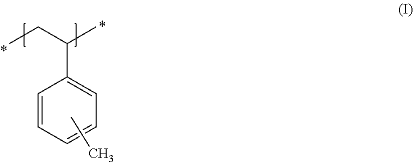

The structural unit (A) has a carbocyclic aromatic structure. The aromatic backbone introduced by the structural unit (A) can impart good compatibility between the hydrocarbon resin polymer and organic solvents, thereby enhancing the solubility of the hydrocarbon resin polymer in the solvents and contributing to improved dispersibility and processability of the resin composition during processing. The present disclosure has found that, compared with hydrocarbon resin polymers including structural units derived from other monovinyl aromatic compounds (such as styrene or α-methylstyrene), a hydrocarbon resin polymer including the structural unit (A) derived from vinyl toluene exhibits improved thermal properties, thermal stability, and electrical performance in its cured product. Without being bound by any particular theory, it is believed that the synergistic effects arising from the structural characteristics of the structural unit (A) and/or its combination with other structural units of the present disclosure can significantly improve the overall performance of the material under high-temperature processing and application environments. As shown in the following embodiments, the cured product of the hydrocarbon resin polymer including the structural unit (A) can exhibit excellent performance in terms of dielectric properties and dimensional stability. In some embodiments, based on 100 mol % of the total structural units in the hydrocarbon resin polymer, the content of the structural unit (A) is 10 to 50 mol %. In some embodiments, the content of the structural unit (A) can be determined by ¹H NMR. When the content of the structural unit (A) falls within the above range, the structural unit (A), in combination with other structural units, enables the hydrocarbon resin polymer of the present disclosure to exhibit good electrical performance, improved thermal properties, high solubility, and/or good processability. In some embodiments, based on 100 mol % of the total structural units in the hydrocarbon resin polymer, the content of the structural unit (A) may be 10 to 45 mol %, 10 to 40 mol %, 10 to 35 mol %, or 10 to 30 mol %. In some embodiments, based on 100 mol % of the total structural units in the hydrocarbon resin polymer, the content of the structural unit (A) may be 13 mol %, 15 mol %, 17 mol %, 18 mol %, 20 mol %, or 25 mol %.

The structural unit (B) derived from a divinyl aromatic compound includes a carbocyclic aromatic structure from the divinyl aromatic compound. As used in the present disclosure, the term “divinyl aromatic compound” refers to a compound including at least one carbocyclic aromatic structure and having at least two vinyl substituents in the overall molecule, wherein the vinyl substituents are bonded to ring carbon atoms of one or more carbocyclic aromatic structures. In some embodiments, the vinyl group may be unsubstituted. In some embodiments, at least one hydrogen atom on the vinyl group may be substituted with a C₁₋₂₀ alkyl group. In some embodiments, the carbocyclic aromatic structure may include 6 to 60 or 6 to 20 ring carbon atoms. In some embodiments, at least one additional hydrogen atom on the ring carbon atoms of the carbocyclic aromatic structure may be substituted with a C₁₋₂₀ alkyl group. Examples of the divinyl aromatic compound include divinylbenzene (DVB), 1,3-diisopropenylbenzene, 1,2-bis(4-vinylphenyl)ethane (BVPE), and p-isopropenyl-α-methylstyrene (IPAMS), but are not limited thereto.

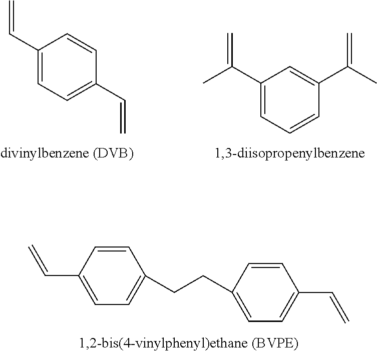

In some embodiments, the structural unit (B) may include a crosslinkable structural unit (B1) and a crosslinked structural unit (B2).

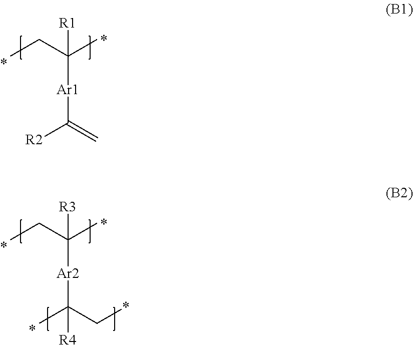

In the crosslinkable structural unit (B1) and the crosslinked structural unit (B2), R1, R2, R3, and R4 are each independently H or a C₁₋₂₀ alkyl group; Ar1 and Ar2 are each a divalent group having a carbocyclic aromatic structure, such as a phenylene group, a biphenylene group, or a divalent aromatic group formed by aromatic rings linked via an alkylene bridge; and * indicates a bonding site at which the crosslinkable structural unit (B1) and/or the crosslinked structural unit (B2) are connected to another group or unit. In some embodiments, the crosslinkable structural unit (B1) may include the following structure, but the present disclosure is not limited thereto:

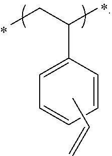

In some embodiments, the crosslinked structural unit (B2) may include the following structure, but the present disclosure is not limited thereto:

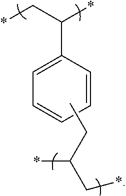

The structural unit (B) can serve as a crosslinking point, and an appropriate content of the structural unit (B) can provide the hydrocarbon resin polymer with a desired cross-linking degree. A hydrocarbon resin polymer including the structural unit (B) can crosslink with other components to form a cured product exhibiting improved thermal properties, thermal stability, and electrical performance. The hydrocarbon resin polymer, having an appropriate cross-linking degree, exhibits enhanced thermal properties, thermal stability, and/or dielectric properties. In some embodiments, based on 100 mol % of the total structural units in the hydrocarbon resin polymer, the content of the structural unit (B) is 15 to 45 mol %. In some embodiments, the content of the structural unit (B) can be determined by ¹H NMR. When the content of the structural unit (B) falls within the above range, it provides the hydrocarbon resin polymer having the desired cross-linking degree. Under this configuration, the crosslinked structure formed by the structural unit (B) contributes to improving the thermal properties of the hydrocarbon resin polymer (for example, a low coefficient of thermal expansion in the thickness direction, e.g., <3%, and a high glass transition temperature, e.g., >190 °C), and its thermal stability and electrical performance, while still maintaining the solubility and processability of the hydrocarbon resin polymer required during processing. In some embodiments, if the content of the structural unit (B) in the hydrocarbon resin polymer is too high (for example, exceeding 45 mol %), the hydrocarbon resin polymer may be prone to oxidation, resulting in poor electrical performance. In some embodiments, if the content of the structural unit (B) in the hydrocarbon resin polymer is too low (for example, less than 15 mol %), the hydrocarbon resin polymer may exhibit may exhibit undesirable resin flow during the process of forming a cured product (i.e., poor processability), and crosslinking with other components may be insufficient, thereby affecting the thermal properties, thermal stability, and electrical performance of the cured product. Furthermore, a resin composition comprising the hydrocarbon resin polymer can form a cured resin body exhibiting good peel strength. In some embodiments, based on 100 mol % of the total structural units in the hydrocarbon resin polymer, the content of the structural unit (B) may be 16 to 40 mol %, 18 to 35 mol %, or 20 to 45 mol %. In some embodiments, based on 100 mol % of a total amount of all units in the hydrocarbon resin polymer, the content of the structural unit (B) may be 38 mol %, 36 mol %, 30 mol %, 25 mol %, or 20 mol %. In some embodiments, based on 100 mol % of a total amount of all units in the hydrocarbon resin polymer, the content of the crosslinkable structural unit (B1) may be 10 to 40 mol %. In some embodiments, based on 100 mol % of a total amount of all units in the hydrocarbon resin polymer, the content of the crosslinkable structural unit (B1) may be 12 to 39 mol %, 13 to 37 mol %, or 15 to 36 mol %. In some embodiments, based on 100 mol % of a total amount of all units in the hydrocarbon resin polymer, the content of the crosslinkable structural unit (B1) may be 14 mol %, 20 mol %, 25 mol %, or 30 mol %.

In some embodiments, a cross-linking degree of the hydrocarbon resin polymer is 0.01 to 0.5. A cross-linking degree within this range enables the cured product to exhibit excellent thermal properties, thermal stability, and/or electrical performance. In some embodiments, when the cross-linking degree of the hydrocarbon resin polymer exceeds 0.5, the processability thereof may decrease. In some embodiments, the cross-linking degree of the hydrocarbon resin polymer may be 0.05 to 0.5. In some embodiments, the cross-linking degree may be 0.08, 0.1, 0.15, 0.18, or 0.2, but the present disclosure is not limited thereto. The cross-linking degree of the hydrocarbon resin polymer is calculated by the following formula:

$$\frac{the content of the crosslinked structural unit ( B 2 ) ( mol \% )}{the content of the structural unit ( B ) ( mol \% )}$$

In some embodiments, the hydrocarbon resin polymer of the present disclosure may further include a structural unit (C) derived from a polycyclic aromatic compound. The polycyclic aromatic compound may have a carbocyclic aromatic structure including two or more aromatic rings. In some embodiments, two or more aromatic rings in the carbocyclic aromatic structure of the polycyclic aromatic compound are fused to each other. In some embodiments, at least one hydrogen atom on a ring carbon atom of the carbocyclic aromatic structure of the polycyclic aromatic compound may be substituted with a C₁₋₂₀ alkyl group. In some embodiments, ring carbon atoms in the carbocyclic aromatic structure of the polycyclic aromatic compound may be replaced with a heteroatom, such as N, O, and/or S. That is, in some embodiments, the carbocyclic aromatic structure of the polycyclic aromatic compound may include a heteroaromatic ring. In some embodiments, the carbocyclic aromatic structure of the polycyclic aromatic compound may include 3 to 60 or 3 to 20 ring carbon atoms. In some embodiments, examples of the polycyclic aromatic compound may include indene, methyl-indene, naphthalene, indole, benzofuran, methyl-naphthalene, fluorene, pyrene, acenaphthylene, phenanthrene, and biphenyl, but the present disclosure is not limited thereto.

In some embodiments, the hydrocarbon resin polymer may include reactive double bonds. As used herein, “reactive double bond” refers to a double bond in the structural unit that is capable of reacting with another compound or polymer. For example, in some embodiments, the reactive double bond includes a double bond on a non-benzene ring in the structural unit (B):

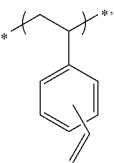

but the present disclosure is not limited thereto.

In some embodiments, introducing a polycyclic aromatic compound (e.g., indene) as a monomer can help control the polymerization reaction, such that the resulting hydrocarbon resin polymer has a lower molecular weight (Mn). In addition, this configuration can also help reduce the hydrogen atom content on reactive double bonds. Due to the above characteristics, a cured resin body formed from the hydrocarbon resin polymer of the present disclosure can exhibit good peel strength, thereby improving the reliability of a resin product including the cured resin body. The hydrogen atom content on the reactive double bonds will be further described in the following paragraphs.

The structural unit (C) derived from a polycyclic aromatic compound has a rigid molecular structure, which can help enhance the glass transition temperature and overall thermal properties of the hydrocarbon resin polymer. In some embodiments, based on 100 mol % of the total structural units in the hydrocarbon resin polymer, the content of the structural unit (C) is 20 to 60 mol %. In some embodiments, the content of the structural unit (C) can be determined by ¹H NMR. When the content of the structural unit (C) falls within the above range, the hydrocarbon resin polymer can exhibit improved thermal properties, such as a higher glass transition temperature, thermal stability, solubility, and/or processability. In some embodiments, based on 100 mol % of the total structural units in the hydrocarbon resin polymer, the content of the structural unit (C) may be 25 to 58 mol %, 28 to 55 mol %, or 30 to 52 mol %. In some embodiments, based on 100 mol % of the total structural units in the hydrocarbon resin polymer, the content of the structural unit (C) may be 22 mol %, 24 mol %, 50 mol %, 48 mol %, or 45 mol %.

In some embodiments, based on 100 mol % of the total structural units in the hydrocarbon resin polymer, the sum of the contents of the structural unit (B) and the structural unit (C) may be 50 to 80 mol %. When the sum of the contents of the structural unit (B) and the structural unit (C) falls within the above range, the hydrocarbon resin polymer can exhibit improved thermal properties and thermal stability. In some embodiments, based on 100 mol % of the total structural units in the hydrocarbon resin polymer, the sum of the contents of the structural unit (B) and the structural unit (C) may be 52 to 75 mol %, 54 to 70 mol %, or 55 to 66 mol %. In some embodiments, based on 100 mol % of the total structural units in the hydrocarbon resin polymer, the sum of the contents of the structural unit (B) and the structural unit (C) may be 53 mol %, 56 mol %, 67 mol %, 68 mol %, or 69 mol %.

In some embodiments, the hydrocarbon resin polymer may not include a structural unit derived from dicyclopentadiene (DCPD) or cyclopentadiene (CPD), but the present disclosure is not limited thereto. In some embodiments, the hydrocarbon resin polymer may further include a structural unit (D), wherein the structural unit (D) is derived from a monovinyl aromatic compound and is different from the structural unit (A). That is, the structural unit (D) is derived from a monovinyl aromatic compound other than vinyl toluene.

As used in the present disclosure, a monovinyl aromatic compound other than vinyl toluene refers to a compound including a carbocyclic aromatic structure in which one hydrogen atom on a ring carbon atom of the carbocyclic aromatic structure is substituted with a vinyl group. In some embodiments, the vinyl group may be unsubstituted. In some embodiments, at least one hydrogen atom on the vinyl group may be substituted with a C₁₋₂₀ alkyl group. In some embodiments, the carbocyclic aromatic structure may include 6 to 60 or 6 to 20 ring carbon atoms. In some embodiments, at least one other hydrogen atom on a ring carbon atom of the carbocyclic aromatic structure may be substituted with a C₂₋₂₀ alkyl group. Examples of monovinyl aromatic compounds other than vinyl toluene may include styrene, α-methylstyrene, ethylstyrene, 2-vinylnaphthalene, or 4-tert-butylstyrene, but the present disclosure is not limited thereto.

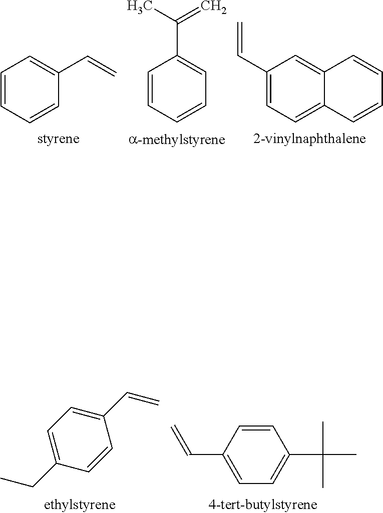

In some embodiments, the structural unit (D) derived from a monovinyl aromatic compound includes a carbocyclic aromatic structure from the monovinyl aromatic compound. For example, in some embodiments, the structural unit (D) may have the structure shown below, but the present disclosure is not limited thereto:

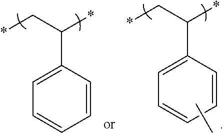

The “*” in the above structure represents a bonding site connected to another group or unit.

In some embodiments, based on 100 mol % of the total structural units in the hydrocarbon resin polymer, the content of the structural unit (D) may be 0.1 to 30 mol %. In some embodiments, the content of the structural unit (D) can be determined by ¹H NMR. The structural unit (D) has a carbocyclic aromatic structure, and the aromatic backbone introduced thereby can impart good compatibility between the hydrocarbon resin polymer and organic solvents, thereby enhancing the solubility of the hydrocarbon resin polymer in the solvents and contributing to improved dispersibility and processability of the resin composition during processing. When the content of the structural unit (D) falls within the above range, the structural unit (D), in combination with other structural units, enables the hydrocarbon resin polymer of the present disclosure to exhibit good electrical performance, good thermal properties, high solubility, and/or good processability. Furthermore, a resin composition including the structural unit (D) can form a cured resin body having good peel strength. In some embodiments, based on 100 mol % of the total structural units in the hydrocarbon resin polymer, the content of the structural unit (D) may be 1 to 28 mol %, 2 to 25 mol %, 3 to 23 mol %, 4 to 21 mol %, or 5 to 19 mol %. In some embodiments, based on 100 mol % of the total structural units in the hydrocarbon resin polymer, the content of the structural unit (D) may be 0.5 mol %, 6 mol %, 20 mol %, 22 mol %, or 24 mol %.

In some embodiments, the hydrogen content on the reactive double bonds of the hydrocarbon resin polymer may be 2 to 10%. When the hydrogen content on the reactive double bonds of the hydrocarbon resin polymer is less than 10%, the hydrocarbon resin polymer is less prone to oxidation during the thermal process or tends to complete crosslinking before oxidation, thereby improving the electrical performance of the hydrocarbon resin polymer. When the hydrogen content on the reactive double bonds of the hydrocarbon resin polymer is greater than 2%, the hydrocarbon resin polymer may exhibit a lower coefficient of thermal expansion in the thickness direction (e.g., <3%) and a higher glass transition temperature (e.g., >190 °C). In some embodiments, the hydrogen content on the reactive double bonds of the hydrocarbon resin polymer may be 2.1% to 9%, 2.3% to 8.5%, 2.5% to 8%, 2.7% to 7.5%, or 3% to 7%. In some embodiments, the hydrogen content on the reactive double bonds of the hydrocarbon resin polymer may be 2.2%, 2.4%, 2.6%, 2.8%, 2.9%, 6%, or 5.9%.

In some embodiments, the number-average molecular weight (Mn) of the hydrocarbon resin polymer may be 5,000 to 20,000 g/mol. When the number-average molecular weight of the hydrocarbon resin polymer falls within the above range, the hydrocarbon resin polymer may exhibit good solubility. In some embodiments, the number-average molecular weight (Mn) of the hydrocarbon resin polymer may be 6,000 to 11,000 g/mol, 7,000 to 10,950 g/mol, or 8,000 to 10,900 g/mol. In some embodiments, the number-average molecular weight (Mn) of the hydrocarbon resin polymer may be 5,500 g/mol, 6,500 g/mol, 7,500 g/mol, 8,100 g/mol, 12,000 g/mol, 14,000 g/mol, or 16,000 g/mol.

In some embodiments, the weight-average molecular weight (Mw) of the hydrocarbon resin polymer may be 10,000 to 250,000 g/mol. When the weight-average molecular weight of the hydrocarbon resin polymer falls within the above range, the hydrocarbon resin polymer may exhibit good solubility, improved processability, and/or good film-forming properties. In some embodiments, the weight-average molecular weight (Mw) of the hydrocarbon resin polymer may be 20,000 to 230,000 g/mol, 25,000 to 220,000 g/mol, 30,000 to 200,000 g/mol, 35,000 to 180,000 g/mol, or 40,000 to 150,000 g/mol. In some embodiments, the weight-average molecular weight (Mw) of the hydrocarbon resin polymer may be 15,000 g/mol, 45,000 g/mol, 50,000 g/mol, 55,000 g/mol, 60,000 g/mol, 65,000 g/mol, 70,000 g/mol, 120,000 g/mol, 130,000 g/mol, or 140,000 g/mol.

In some embodiments, the polymer dispersity index (PDI) of the hydrocarbon resin polymer may be less than 16, wherein the PDI is the ratio of the weight-average molecular weight (Mw) to the number-average molecular weight (Mn) (Mw/Mn) of the hydrocarbon resin polymer. In some embodiments, the PDI of the hydrocarbon resin polymer may be 1, 2, 3, 4, 7, 8, 9, 11, 13, 15, or 15.8.

In some embodiments, a hydrocarbon resin polymer may have a molecular weight distribution within a specific range. To describe the degree of molecular weight distribution, a parameter Fp is used herein as an auxiliary indicator. The Fp is calculated using the following equation, wherein the PDI is as defined above:

Fp=1/PDI.

In some embodiments, the hydrocarbon resin polymer may have an Fp of 0.05 to 1.0. When the Fp of the hydrocarbon resin polymer falls within the above range, the polymer may exhibit good solubility and/or improved processability, making it suitable for processes such as calendaring, coating, extrusion, or impregnation. In some embodiments, the Fp of the hydrocarbon resin polymer may be 0.05 to 0.9, 0.05 to 0.8, 0.05 to 0.7, 0.05 to 0.6, 0.05 to 0.5, 0.05 to 0.4, or 0.05 to 0.3. In some embodiments, the Fp of the hydrocarbon resin polymer may be 0.07, 0.08, 0.10, or 0.15.

To characterize the structural configuration related to peel strength performance, a parameter PL is additionally defined herein as an indicator describing the structural parameter configuration in the hydrocarbon resin polymer associated with peel strength performance. The PL is calculated using the following equation, wherein Mn is the number-average molecular weight of the hydrocarbon resin polymer, and PDI is as defined above:

PL=Mn×PDI×H/100,

wherein Mn, PDI, and H are input parameters used for the calculation. H represents a numerical value expressed as H % and is used directly in the calculation without converting the percentage. The PL obtained by substituting these parameters into the above equation is a calculated indicator value that reflects the relative differences among different structural configurations.

For example, in one embodiment, the number-average molecular weight (Mn) of the hydrocarbon resin polymer is 9,553 g/mol, the dispersity index (PDI) is 4.582, and the hydrogen content on the reactive double bonds (H %) is 5.859%. In this embodiment, Mn is substituted for 9,553, PDI is substituted for 4.582, and H is substituted for the numerical value corresponding to its percentage form, 5.859, into the above equation for PL calculation, obtaining a PL value of 9,553×4.582×5.859/100=2,564.54.

In some embodiments, the hydrocarbon resin polymer may have a PL in the range of 400 to 7,000. When the PL of the hydrocarbon resin polymer falls within this range, it can help improve the peel strength performance of the cured resin body formed from the hydrocarbon resin polymer. In some embodiments, the PL of the hydrocarbon resin polymer may be 500 to 6,900, 600 to 6,800, 700 to 6,700, 800 to 6,600, 900 to 6,500, 1,000 to 6,400, or 1,200 to 6,300. In some embodiments, the PL of the hydrocarbon resin polymer may be 6,550, 6,450, 6,350, 1,000, 1,250, 1,200, or 5,500.

In some embodiments, the ratio of the parameter PL associated with peel strength performance to the indicator Fp associated with molecular weight distribution (PL/Fp) of the hydrocarbon resin polymer may range from 4,000 to 100,000. When PL/Fp falls within the above range, the hydrocarbon resin polymer can maintain good solubility and processability while providing a certain level of peel strength. In some embodiments, the PL/Fp of the hydrocarbon resin polymer may be 5,000 to 99,500, 5,500 to 99,000, or 6,000 to 98,500. In some embodiments, the PL/Fp of the hydrocarbon resin polymer may be 5,800, 5,900, 6,200, 6,300, 6,400, 98,300, or 98,100.

In summary, the hydrocarbon resin polymers disclosed herein can exhibit good electrical performance, excellent thermal properties, high solubility, and/or good processability. In some embodiments, the hydrocarbon resin polymers disclosed herein can further form a cured resin body having good peel strength. In some embodiments, the hydrocarbon resin polymers disclosed herein can achieve a favorable balance among properties such as electrical performance (dielectric properties), thermal properties, processability, and the formation of a cured resin body having good peel strength.

Some embodiments of the present disclosure provide a method for manufacturing a hydrocarbon resin polymer. The method for manufacturing the hydrocarbon resin polymer disclosed the present disclosure includes performing a polymerization process to form a reaction product including the above-mentioned hydrocarbon resin polymer from a mixture. The mixture includes a divinyl aromatic compound and vinyl toluene.

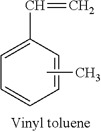

In some embodiments, examples of the divinyl aromatic compound may include divinylbenzene, 1,3-diisopropenylbenzene, 1,2-bis(4-vinylphenyl)ethane, and para-isopropenyl-α-methylstyrene, but the present disclosure is not limited thereto.

In some embodiments, based on 100 mol % of all components in the mixture, the content of vinyl toluene may range from 20 to 70 mol %. In some embodiments, based on 100 mol % of all components in the mixture, the content of vinyl toluene may be 23 to 60 mol %, 25 to 55 mol %, or 27 to 50 mol %. In some embodiments, based on 100 mol % of all components in the mixture, the content of the divinyl aromatic compound may range from 5 to 55 mol %. In some embodiments, based on 100 mol % of all components in the mixture, the content of the divinyl aromatic compound may be 11 to 40 mol %, 13 to 35 mol %, or 15 to 30 mol %. In some embodiments, based on 100 mol % of all components in the mixture, the content of the divinyl aromatic compound may be 10 mol %, 45 mol %, or 50 mol %.

In some embodiments, the mixture may further include a polycyclic aromatic compound. In some embodiments, examples of the polycyclic aromatic compound may include indene, methyl indene, naphthalene, indole, benzofuran, methyl naphthalene, fluorene, pyrene, acenaphthylene, phenanthrene, or biphenyl, but the present disclosure is not limited thereto. In some embodiments, based on 100 mol % of all components in the mixture, the content of the polycyclic aromatic compound may range from 15 to 40 mol %. In some embodiments, based on 100 mol % of all components in the mixture, the content of the polycyclic aromatic compound may be 15 to 37 mol %, 17 to 35 mol %, or 19 to 33 mol %.

In some embodiments, the mixture may exclude reactive monomers such as dicyclopentadiene (DCPD) or cyclopentadiene (CPD). Since dicyclopentadiene or cyclopentadiene may be irritating and pose potential safety risks under operating and processing conditions, they may be replaced with a polycyclic aromatic compound (e.g., indene). This allows the resulting hydrocarbon resin polymer to exhibit excellent performance in properties such as glass transition temperature, dimensional stability, and peel strength, while also reducing potential safety risks during processing and improving overall operational safety.

In some embodiments, the mixture may further include a mono-vinyl aromatic compound, wherein the mono-vinyl aromatic compound does not include vinyl toluene. In some embodiments, examples of the mono-vinyl aromatic compound may include styrene, α-methyl styrene, ethyl styrene, 2-vinyl naphthalene, or 4-tert-butylstyrene, but the present disclosure is not limited thereto. In some embodiments, based on 100 mol % of all components in the mixture, the content of the mono-vinyl aromatic compound may range from 1 to 35 mol %. In some embodiments, based on 100 mol % of all components in the mixture, the content of the mono-vinyl aromatic compound may be 2 to 30 mol %, 3 to 29 mol %, 4 to 27 mol %, or 5 to 25 mol %.

In some embodiments, the polymerization process may include adding a catalyst to the mixture. The catalyst may include titanium tetrachloride (TiCl₄) and/or boron trifluoride complexes. Examples of boron trifluoride complexes may include boron trifluoride tetrahydrofuran complex (BF₃-THF), boron trifluoride methanol complex (BF₃-MeOH), boron trifluoride hydrate (BF₃—H₂O), boron trifluoride diethyl ether complex (BF₃—OEt₂), boron trifluoride anisole complex (BF₃-PhOMe), boron trifluoride acetic acid complex (BF₃—AcOH), or any combination thereof, but the present disclosure is not limited thereto. In some embodiments, the molar ratio of the catalyst to the mixture may be 0.1-7:100. In some embodiments, the molar ratio of the catalyst to the mixture may be 0.2-6:100, 0.3-5:100, or 0.4-4.5:100, but the present disclosure is not limited thereto.

In some embodiments, the reaction temperature, reaction time, and the ratio of raw materials to catalyst in the polymerization process may affect the distribution of the structural units (such as structural unit (A), structural unit (B), structural unit (C), structural unit (D), etc.) in the resulting hydrocarbon resin polymer. In some embodiments, the polymerization process may include a reaction temperature of 0 to 100 °C. In some embodiments, the polymerization process may include a reaction temperature of 0 to 80 °C, 0 to 60 °C, 0 to 40 °C, or 0 to 30 °C. In some embodiments, the polymerization process may include a reaction temperature of 5 to 80 °C, 10 to 60 °C, or 15 to 40 °C. In some embodiments, the polymerization process may include a reaction time of 0.1 to 10 hours. In some embodiments, the polymerization process may include a reaction time of 0.2 to 8 hours, 0.3 to 6 hours, or 0.4 to 4 hours.

In some embodiments, the method for manufacturing the hydrocarbon resin polymer of the present disclosure may further include subjecting the reaction product to a purification process. The purification process may include a precipitation purification process or a liquid-liquid extraction process, but the present disclosure is not limited thereto. In some embodiments, the purification process may include a precipitation purification step. In this step, the mother liquor of the polymer solution may be slowly added into a precipitation solvent to form a resin precipitate. The precipitation solvent may include an alcohol solvent, such as isopropyl alcohol (IPA) or methanol. After the resin precipitate is formed, solid-liquid separation may be carried out by filtration to obtain a resin solid, which may be further washed with the precipitation solvent to remove residual impurities. In some embodiments, the precipitation step may be repeated one or more times to improve purity. In some embodiments, the obtained resin solid may be redissolved in an organic solvent (such as tetrahydrofuran (THF)) and then subjected to precipitation purification step again to further remove low-molecular-weight byproducts or unreacted monomers.

In some embodiments, the purification process may further include a water extraction step. In this embodiment, the water extraction step uses water. Specifically, the water extraction step includes adding the polymer solution to 1.1 times of an aqueous mixture to perform liquid-liquid extraction. In some embodiments, the aqueous mixture may include isopropyl alcohol (IPA). In this embodiment, the weight ratio of water to isopropyl alcohol (water/IPA) in the aqueous mixture may be greater than 1. In some embodiments, the weight ratio of water to isopropyl alcohol (water/IPA) in the aqueous mixture may be 55/45, 60/40, 80/20, or 90/10, but the present disclosure is not limited thereto. In embodiments where the mixture used in the method for producing the hydrocarbon resin polymer does not include dicyclopentadiene or cyclopentadiene, the aqueous mixture used in the purification process may primarily include water (for example, the weight ratio of water to isopropyl alcohol (water/IPA) may be about 90/10 or higher). Accordingly, the amount of organic solvent used in the purification process can be reduced. Compared with conventional purification processes that use a high amount of organic solvents, the method for producing the hydrocarbon resin polymer disclosed herein is more environmentally beneficial.

The specific structure of the hydrocarbon resin polymer obtained by the manufacturing method of the present disclosure has been described above and will not be repeated herein. The hydrocarbon resin polymer obtained according to the manufacturing method of the present disclosure may exhibit good electrical properties, thermal properties, thermal stability, solubility, and/or processability. In some embodiments, the hydrocarbon resin polymer obtained according to the manufacturing method of the present disclosure may further form a cured resin body having good peel strength. In some embodiments, the hydrocarbon resin polymer obtained according to the manufacturing method of the present disclosure can achieve a good balance among properties such as electrical performance (dielectric properties), thermal properties, thermal stability, solubility, processability, and the ability to form a cured resin body with good peel strength.

Some embodiments of the present disclosure provide a resin composition including the hydrocarbon resin polymer described above. In some embodiments, the resin composition is in the form of a varnish and is suitable for use in electronic materials, for example, in impregnation or coating processes for fiber substrates material.

In some embodiments, the resin composition may further include a solvent. The solvent may be an aromatic solvent, an aliphatic solvent, an alicyclic solvent, a halogenated hydrocarbon solvent, an ether solvent, an ester solvent, a ketone solvent, or a mixture thereof. Examples of the solvent include, but are not limited to, toluene, xylene, trimethylbenzene, ethylbenzene, isopropylbenzene, trifluoromethylbenzene, fluorobenzene, chlorobenzene, bromobenzene, iodobenzene, dichloroethane, chloroform, cyclohexane, methylcyclohexane, n-hexane, heptane, p-menthane, tetrahydrofuran, ethyl acetate, anisole, butanone, methyl isobutyl ketone, propylene glycol monomethyl ether acetate (PGMEA), or a combination thereof. In some embodiments, the resin composition of the present disclosure may include 5 to 350 parts by weight of an organic solvent, based on 100 parts by weight of the hydrocarbon resin polymer. In some embodiments, the resin composition of the present disclosure may further include an optional photoinitiator, an optional inhibitor, an optional crosslinking agent, an optional leveling agent, or a combination thereof.

The resin composition including the hydrocarbon resin polymer of the present disclosure may exhibit good solubility, processability, film-forming properties, electrical performance, thermal properties, thermal stability, and/or the ability to form a cured resin body having good peel strength.

Some embodiments of the present disclosure provide a curable composite material including the hydrocarbon resin polymer described above. In some embodiments, the curable composite material may include a fiber substrate material and the hydrocarbon resin polymer formed on the fiber substrate material. In some embodiments, the curable composite material may be in the form of a prepreg.

In some embodiments, a method for manufacturing the curable composite material may include the following steps: providing a resin composition including the hydrocarbon resin polymer of the present disclosure; impregnating a fiber substrate material with the resin composition to form a curable material; and heating the curable material under desired heating conditions (for example, at about 100 °C to about 180 °C for about 1 minute to about 15 minutes) to partially cure the resin composition on the fiber substrate material, thereby obtaining a curable composite material in a semi-cured state.

Examples of the fiber substrate material may include glass fiber cloth, aramid cloth, polyester cloth, glass fiber nonwoven fabric, aramid nonwoven fabric, polyester nonwoven fabric, pulp paper, printer paper, other suitable materials, or any combination thereof, but the present disclosure is not limited thereto. In some embodiments, the fiber substrate material may be a glass fiber cloth having a dielectric loss tangent (Df) of less than or equal to 0.0030, wherein the dielectric loss tangent (Df) is measured at a frequency of about 28 GHz (Df @ 28 GHz).

In some embodiments, the curable composite material of the present disclosure may have a dielectric loss tangent (Df @ 28 GHz) of less than 0.01. In some embodiments, the curable composite material of the present disclosure may have a dielectric loss tangent (Df @ 28 GHz) of less than or equal to 0.00250, less than or equal to 0.00220, less than or equal to 0.00200, less than or equal to 0.00180, or less than or equal to 0.00170.

Some embodiments of the present disclosure provide a cured resin body formed from the hydrocarbon resin polymer described above. In some embodiments, the cured resin body may be a copper clad laminate (CCL), which can be formed from the curable composite material described above by a hot-pressing process.

Specifically, in some embodiments, the cured resin body is manufactured by laminating the above-mentioned curable composite material (i.e., semi-cured sheet) with a copper foil and then heating it to 210 °C by a hot-pressing process to form the cured resin body.

Some embodiments of the present disclosure provide another cured resin body and a resin product including the cured resin body. In some embodiments, the resin product may be a resin-coated copper foil (RCC).

In some embodiments, the resin product may include a substrate base and the cured resin body formed on the substrate base. In some embodiments, the resin product may include one or more substrate bases and the cured resin body formed on at least one surface of at least one of the substrate bases. In some embodiments, the resin product may be obtained by coating the above-described resin composition onto at least one substrate base to form a curable resin layer, and curing the resin composition under desired heating conditions to form the cured resin body.

In some embodiments, the above-described resin product (e.g., a resin-coated metal foil) may be further laminated with one or more layers of material and subjected to a hot-pressing process to form another resin product. In some embodiments, the substrate base may include a metal foil. In some embodiments, the metal foil may include copper foil.

The method of coating the resin composition onto at least one surface of the metal foil is not particularly limited. Specifically, the coating method may include introducing the resin composition into a coating device, and coating the resin composition onto at least one surface of the metal foil to a desired thickness. Examples of the coating device include a comma coater, blade coater, lip coater, roll coater, extrusion coater, reverse coater, transfer roll coater, gravure coater, spray coater, and the like, but the present disclosure is not limited thereto.

The hot-pressing conditions in the hot-pressing process can be appropriately set according to the thickness of the metal-clad laminate to be produced and the type of resin composition used in the prepreg or resin-coated copper foil. For example, the hot-pressing conditions may be set to a temperature of 180 to 210 °C, a pressure of 1.0 to 3.0 MPa, and a duration of 60 to 180 minutes.

The curable composite material, cured resin body, and/or resin product including the hydrocarbon resin polymer of the present disclosure may exhibit good electrical performance and/or thermal properties. Furthermore, the layer or film including the hydrocarbon resin polymer in the curable composite material, cured resin body, and/or resin product has good peel strength, which can improve the reliability of the curable composite material, cured resin body, and/or resin product.

One or more embodiments of the present disclosure will now be described in detail with reference to the following examples. However, these examples are provided for illustrative purposes only and are not intended to limit the scope of the present disclosure.

### [Preparation of Hydrocarbon Resin Polymers 1 to 18]

### Polymerization Process

Under a nitrogen atmosphere, the respective monomer amounts shown in Table 1 and the corresponding solvents shown in Table 1 were added to a 1 L four-neck vertical jacketed reactor, and the reactants were stirred using a single-layer four-blade flat impeller at a stirring speed of 300 rpm to form a mixture. At the temperature indicated in Table 1, the boron trifluoride diethyl etherate catalyst in the amount shown in Table 1 was added to the mixture at a rate of 0.25 mL/min using a syringe pump. After the addition of the catalyst was complete, the reaction was carried out for the reaction time specified in Table 1. Thereafter, isopropanol and water were added to terminate the reaction, thereby obtaining polymer mother solutions 1 to 18.

### Purification Process A

First, polymer mother solutions 1 to 5 and 7 to 17 were filtered to remove impurities and insoluble matter. Under mechanical stirring at 500 rpm, polymer mother solution was slowly added dropwise via a feed funnel into isopropyl alcohol in an amount of five times its weight to obtain a white crude resin product. Solid-liquid separation was performed by vacuum filtration to obtain a white solid. The white solid was then redissolved in tetrahydrofuran to form a new mother solution, which was again precipitated using isopropyl alcohol (weight ratio of mother solution to isopropyl alcohol=1:5). After filtration, a purer white resin solid was obtained. Finally, the white solid was washed with isopropyl alcohol to remove impurities, and the solvent was removed by heating and stirring under vacuum in a nitrogen atmosphere, yielding white powdery hydrocarbon resin polymers 1 to 5 and 7 to 17.

### Purification Process B

First, polymer mother solutions 6 and 18 were filtered to remove impurities and insoluble matter. Under mechanical stirring at 500 rpm, polymer mother solution was slowly added dropwise via a feed funnel into a water/IPA (>1, g/g) mixture in an amount of 1.1 times its weight. Two liquid-liquid extractions were performed, and the organic layer was collected. Finally, the solvent was removed using a rotary evaporator to obtain varnish-like samples including hydrocarbon resin polymers 6 and 18.

The raw materials, reaction temperatures, reaction times, and amounts of catalyst used to form hydrocarbon resin polymers 1 to 18 of the present disclosure are listed in Table 1 below. The mol % of each raw material listed in Table 1 refers to the content of each component, based on a total of 100 mol of all components in the mixture (excluding the catalyst). The mol % of the catalyst listed in Table 1 refers to the amount of catalyst relative to 100 mol % of the total monomer content in the mixture.

TABLE 1

| Raw Materials | 1 | 2 | 3 | 4 | 5 | 6 |
|---|---|---|---|---|---|---|
| Indene (mol %) | 20 | 25 | 25 | 25 | 27 | 27 |
| Divinylbenzene (mol %) | 26.5 | 18.9 | 17.01 | 24 | 24 | 24 |
| Ethylstyrene (mol %) | 23.5 | 11.1 | 9.99 | 6 | 6 | 6 |
| Vinyltoluene (mol %) | 30 | 45 | 48 | 45 | 43 | 43 |
| Styrene (mol %) | 0 | 0 | 0 | 0 | 0 | 0 |
| Reaction Temperature (°C) | 20 | 25 | 25 | 25 | 25 | 20 |
| Reaction Time (h) | 1 | 0.5 | 1 | 0.5 | 1 | 1 |
| Catalyst (mol %, based on | 0.4 | 0.5 | 0.5 | 0.5 | 0.5 | 0.5 |
| total monomer content) | | | | | | |
| Solvent | toluene | toluene | toluene | toluene | toluene | toluene |
| Yield (%) | 66 | 68 | 64 | 78 | 65 | 60 |
| Raw Materials | 7 | 8 | 9 | 10 | 11 | 12 |
| Indene (mol %) | 30 | 20 | 10 | 40 | 25 | 40 |
| Divinylbenzene (mol %) | 24 | 0 | 12.6 | 9.45 | 18.9 | 6.3 |
| Ethylstyrene (mol %) | 6 | 0 | 7.4 | 5.55 | 11.1 | 3.7 |
| Vinyltoluene (mol %) | 40 | 80 | 70 | 45 | 45 | 50 |
| Styrene (mol %) | 0 | 0 | 0 | 0 | 0 | 0 |
| Reaction Temperature (°C) | 25 | 20 | 20 | 60 | 60 | 60 |
| Reaction Time (h) | 1.5 | 0.5 | 0.5 | 0.1 | 0.1 | 0.3 |
| Catalyst (mol %, based on | 0.7 | 0.4 | 0.4 | 0.4 | 0.5 | 0.4 |
| total monomer content) | | | | | | |
| Solvent | toluene | toluene | toluene | toluene | toluene | toluene |
| Yield (%) | 87 | 67 | 63 | 39 | 55 | 43 |
| Raw Materials | 13 | 14 | 15 | 16 | 17 | 18 |
| Indene (mol %) | 27 | 5 | 0 | 0 | 0 | 0 |
| Divinylbenzene (mol %) | 24 | 48 | 32 | 52 | 32 | 63 |
| Ethylstyrene (mol %) | 6 | 12 | 8 | 13 | 8 | 37 |
| Vinyltoluene (mol %) | 0 | 35 | 60 | 35 | 0 | 0 |
| Styrene (mol %) | 43 | 0 | 0 | 0 | 60 | 0 |
| Reaction Temperature (°C) | 25 | 25 | 20 | 20 | 20 | 20 |
| Reaction Time (h) | 1.5 | 0.1 | 0.25 | 0.25 | 1 | 0.33 |
| Catalyst (mol %, based on | 0.5 | 0.7 | 0.1 | 0.1 | 1 | 1 |
| total monomer content) | | | | | | |
| Solvent | toluene | toluene | toluene | toluene | toluene | toluene |
| Yield (%) | 33 | 53 | 54 | 65 | 78 | 65 |

### [Structural Analysis of Hydrocarbon Resin Polymers 1 to 18]

0.05 g of each hydrocarbon resin polymer 1 to 18 was weighed, and 1.0 g of deuterated chloroform (CDCl₃) was added to prepare samples 1 to 18. The ¹H-NMR spectra of samples 1 to 18 were measured at 25 °C using a nuclear magnetic resonance (NMR) spectrometer (JEOL, JNM-ECZ400S). Based on the obtained ¹H-NMR spectra, the structural compositions of hydrocarbon resin polymers 1 to 18 were analyzed, and it was determined that hydrocarbon resin polymers 1 to 18 include a structural unit (A) represented by Chemical Formula (I), a structural unit (B) derived from a divinyl aromatic compound, a structural unit (C) derived from a polycyclic aromatic compound, and a structural unit (D) derived from a monovinyl aromatic compound and different from the structural unit (A).

### [Measurement of Content of Crosslinkable Structural Unit (B1)]

The structures of hydrocarbon resin polymers 1 to 18 were analyzed by NMR (JEOL, JNM-ECZ400S/L1) and GPC (Waters), using CDCl₃ as the solvent and the CDCl₃ resonance signal as an internal standard, to determine the content of crosslinkable structural units (B1) in hydrocarbon resin polymers 1 to 18.

The contents of structural units (A), (B), (C), (D), crosslinkable structural units (B1), and crosslinked structural units (B2) in hydrocarbon resin polymers 1 to 18, as well as the cross-linking degree (content of crosslinked structural units (B2)/content of structural units (B)), are listed in Table 2 below. In Table 2, “E” indicates a structural unit derived from Ethylstyrene, and “S” indicates a structural unit derived from Styrene.

TABLE 2

| | Hydrocarbon resin polymer | | | | | |
|---|---|---|---|---|---|---|
| | 1 | 2 | 3 | 4 | 5 | 6 |
| Structural Unit (A) | 19 | 31 | 30 | 32 | 29 | 28 |
| (mol %) | | | | | | |
| Structural Unit (D) | E = 18 | E = 12 | E = 11 | E = 9 | E = 7 | E = 7 |
| (mol %) | | | | | | |
| Structural Units | 37 | 43 | 41 | 41 | 36 | 35 |
| (A) + (D) (mol %) | | | | | | |
| Structural Unit (B) | 31 | 21 | 19 | 34 | 29 | 29 |
| (mol %) | | | | | | |
| Structural Unit (B1) | 29 | 15 | 15 | 18 | 23 | 21 |
| (mol %) | | | | | | |
| Structural Unit (B2) | 2 | 6 | 4 | 16 | 6 | 8 |
| (mol %) | | | | | | |
| Cross-Linking Degree | 0.06 | 0.29 | 0.21 | 0.47 | 0.21 | 0.28 |
| Structural Units | 48 | 46 | 45 | 50 | 52 | 49 |
| (A) + (B1) (mol %) | | | | | | |
| Structural Unit (C) | 32 | 36 | 40 | 25 | 35 | 36 |
| (mol %) | | | | | | |
| Structural Units | 63 | 57 | 59 | 59 | 64 | 65 |
| (B) + (C) (mol %) | | | | | | |
| Structural Unit (B)/ | 1.632 | 0.677 | 0.633 | 1.063 | 1.000 | 1.036 |
| Structural Unit (A) | | | | | | |

| | Hydrocarbon resin polymer | | | | | |
|---|---|---|---|---|---|---|
| | 7 | 8 | 9 | 10 | 11 | 12 |
| Structural Unit (A) | 27 | 68.45 | 58.1 | 30.5 | 30.3 | 37.7 |
| (mol %) | | | | | | |
| Structural Unit (D) | E = 8 | E = 0 | E = 12.8 | E = 3.4 | E = 6.9 | E = 6.1 |
| (mol %) | | | | | | |
| Structural Units | 35 | 68.45 | 70.9 | 33.9 | 37.2 | 44.1 |
| (A) + (D) (mol %) | | | | | | |
| Structural Unit (B) | 31 | 0 | 21.7 | 5.8 | 11.7 | 10.5 |
| (mol %) | | | | | | |
| Structural Unit (B1) | 23 | 0 | 13.7 | 4.7 | 7.4 | 4.6 |
| (mol %) | | | | | | |
| Structural Unit (B2) | 8 | 0 | 8 | 1.1 | 4.3 | 5.9 |
| (mol %) | | | | | | |
| Cross-Linking Degree | 0.26 | 0.00 | 0.37 | 0.19 | 0.37 | 0.56 |
| Structural Units | 50 | 68.45 | 71.8 | 35.2 | 37.7 | 42.3 |
| (A) + (B1) (mol %) | | | | | | |
| Structural Unit (C) | 34 | 31.55 | 7.4 | 60.3 | 51.1 | 45.4 |
| (mol %) | | | | | | |
| Structural Units | 65 | 31.55 | 29.1 | 66.1 | 62.8 | 55.9 |
| (B) + (C) (mol %) | | | | | | |
| Structural Unit (B)/ | 1.148 | 0.000 | 0.373 | 0.190 | 0.386 | 0.279 |
| Structural Unit (A) | | | | | | |

| | Hydrocarbon resin polymer | | | | | |
|---|---|---|---|---|---|---|
| | 13 | 14 | 15 | 16 | 17 | 18 |
| Structural Unit (A) | 0 | 21.42 | 44.41 | 25.64 | 0 | 0 |
| (mol %) | | | | | | |
| Structural Unit (D) | S = 24 | E = 12.89 | E = 1.12 | E = 14.87 | S = 40.5 | E = 37.04 |
| (mol %) | E = 13 | | | | E = 11.8 | |
| Structural Units | 37 | 34.31 | 55.53 | 40.51 | 52.3 | 37.04 |
| (A) + (D) (mol %) | | | | | | |
| Structural Unit (B) | 22 | 51.55 | 44.47 | 59.49 | 47.58 | 62.96 |
| (mol %) | | | | | | |
| Structural Unit (B1) | 19 | 51 | 42.37 | 54.63 | 29.03 | 35.76 |
| (mol %) | | | | | | |
| Structural Unit (B2) | 3 | 0.55 | 2.1 | 4.86 | 18.55 | 27.2 |
| (mol %) | | | | | | |
| Cross-Linking Degree | 0.14 | 0.01 | 0.05 | 0.08 | 0.39 | 0.43 |
| Structural Units | 19.00 | 72.42 | 86.78 | 80.27 | 29.03 | 35.76 |
| (A) + (B1) (mol %) | | | | | | |
| Structural Unit (C) | 41 | 14.13 | 0 | 0 | 0 | 0 |
| (mol %) | | | | | | |
| Structural Units | 63 | 65.68 | 44.47 | 59.49 | 47.58 | 63 |
| (B) + (C) (mol %) | | | | | | |
| Structural Unit (B)/ | — | 2.407 | 1.001 | 2.320 | 1.856 | 2.363 |
| Structural Unit (A) | | | | | | |

### [Measurement of Hydrogen Atom Content on Reactive Double Bonds]

The hydrocarbon resin polymers 1 to 18 were respectively dissolved in deuterated chloroform (CDCl₃). NMR (JEOL, JNM-ECZ400S/L1) was used to respectively measure hydrogen atom content on double bonds and reactive double bonds of the hydrocarbon resin polymers 1 to 18. Specifically, the hydrogen atom content on reactive double bonds was calculated by dividing the sum of integral values of hydrogens on reactive double bonds by the sum of integral values of all hydrogens, thereby obtaining the hydrogen atom content on reactive double bonds of the hydrocarbon resin polymers 1 to 18. For example, based on the ¹H-NMR spectrum of hydrocarbon resin polymer 3, it can be seen that the hydrogen atom content on the reactive double bonds of hydrocarbon resin polymer 3 is 4.12% (calculated as the sum of the integral values of the hydrogens on the reactive double bonds (i.e., 1) divided by the sum of the integral values of all hydrogens (i.e., 24.2849)).

### [Measurement of Number-Average Molecular Weight (Mn), Polymer Dispersity Index (PDI), and Weight-Average Molecular Weight (Mw)]

Using a gel permeation chromatography (GPC) system (Waters APC, column: Waters Acquity XT 900) with polystyrene as the standard, 0.01 g of each sample of hydrocarbon resin polymers 1 to 18 was dissolved in 5 mL of tetrahydrofuran (THF), filtered by a 0.22 m filter membrane, and analyzed using the instrument to determine the number-average molecular weight (Mn), polymer dispersity index (PDI), and weight-average molecular weight (Mw) of hydrocarbon resin polymers 1 to 18. Specifically, the PDI is defined as the ratio of the weight-average molecular weight (Mw) to the number-average molecular weight (Mn) of the hydrocarbon resin polymer (Mw/Mn), and the weight-average molecular weight (Mw) can be calculated from the PDI and Mn. The measured results of the dispersity index (PDI), number-average molecular weight (Mn), hydrogen atom content on reactive double bonds, Fp, PL, and PL/Fp of hydrocarbon resin polymers 1 to 18 are listed in Table 3 below.

TABLE 3

| | Hydrocarbon Resin Polymer | | | | | |
|---|---|---|---|---|---|---|
| | 1 | 2 | 3 | 4 | 5 | 6 |
| Number-Average | 9553 | 8678 | 8276 | 10782 | 10888 | 9000 |
| Molecular Weight | | | | | | |
| (g/mol) | | | | | | |
| Dispersity Index | 4.582 | 5.0 | 5.0 | 9.7 | 6.0 | 15.6 |
| Weight-Average | 43772 | 43390 | 41380 | 104585 | 65328 | 140400 |
| Molecular Weight | | | | | | |
| (g/mol) | | | | | | |
| Hydrogen Atom | 5.859 | 3.06 | 4.12 | 3.71 | 4.77 | 4.48 |
| Content (%) | | | | | | |
| Fp (1/PDI) | 0.22 | 0.20 | 0.20 | 0.10 | 0.17 | 0.06 |
| PL (Mn*PDI*H/100) | 2564.54 | 1327.73 | 1704.86 | 3880.12 | 3116.15 | 6285.17 |
| PL/Fp | 11750.72 | 6638.67 | 8524.28 | 37637.15 | 18696.87 | 98048.65 |

Hydrocarbon Resin Polymer

| | 7 | 8 | 9 | 10 | 11 | 12 |
|---|---|---|---|---|---|---|
| Number-Average | 9816 | 5427 | 9867 | 4753 | 8033 | 4530 |
| Molecular Weight | | | | | | |
| (g/mol) | | | | | | |
| Dispersity Index | 10.7 | 2.869 | 6.6 | 2.062 | 4.257 | 2.8 |
| Weight-Average | 105031 | 15570 | 65122 | 9801 | 34196 | 12684 |
| Molecular Weight | | | | | | |
| (g/mol) | | | | | | |
| Hydrogen Atom | 4.92 | 0.0 | 2.72 | 1.06 | 1.6287 | 0.992 |
| Content (%) | | | | | | |
| Fp (1/PDI) | 0.09 | 0.35 | 0.15 | 0.48 | 0.23 | 0.36 |
| PL (Mn*PDI*H/100) | 5167.54 | 0.00 | 1771.32 | 104.20 | 556.96 | 125.85 |
| PL/Fp | 55292.62 | 0.00 | 11690.74 | 214.86 | 2370.96 | 352.39 |

| | Hydrocarbon Resin Polymer | | | | | |
|---|---|---|---|---|---|---|
| | 13 | 14 | 15 | 16 | 17 | 18 |
| Number-Average | 7023 | 15586 | 12288 | 14153 | 15743 | 22826 |
| Molecular Weight | | | | | | |
| (g/mol) | | | | | | |
| Dispersity Index | 3.2 | 10.42 | 5.8 | 6.0 | 14.3 | 11.2 |
| Weight-Average | 22474 | 162406 | 71270 | 84918 | 225125 | 255,651 |
| Molecular Weight | | | | | | |
| (g/mol) | | | | | | |
| Hydrogen Atom | 5.865 | 10.226 | 8.354 | 10.786 | 6.08 | 12.74 |
| Content (%) | | | | | | |
| Fp (1/PDI) | 0.31 | 0.10 | 0.17 | 0.17 | 0.07 | 0.09 |
| PL (Mn*PDI*H/100) | 1318.18 | 16607.65 | 5954.18 | 9159.32 | 13687.59 | 32569.96 |
| PL/Fp | 4218.18 | 173051.71 | 34534.24 | 54955.93 | 195732.6 | 364783.6 |

### [Measurement of Electrical Properties of Hydrocarbon Resin Polymers 1 to 18]

15 g of each of hydrocarbon resin polymers 6 and 14 to 18 was dissolved in 15 g of toluene to form a mixture. The mixture was stirred until the hydrocarbon resin polymer was completely dissolved, thereby forming resin compositions 6 and 14 to 18, and the resin compositions 6 and 14 to 18 were examined to determine whether they were clear. Glass fiber cloth (Asahi 2116, Dk/Df=3.3/0.0030 at 28 GHz) was individually impregnated with resin compositions 1 to 18 for approximately 16 hours to form curable composite materials 1 to 18. The curable composite materials 1 to 18 were then baked at 130 °C for 10 minutes to form cured resin bodies 6 and 14 to 18. Using network analyzer software (Keysight, P5007A, SCR), the dielectric constant/loss tangent (Dk/Df) of the cured resin bodies 1 to 18 at 28 GHz and the R.C. % were measured. The results are listed in Table 4 below.

R.C. % (Resin Content)=((Weight after baking−Weight of glass fiber cloth)/Weight after baking)×100%

TABLE 4

| Cured Resin | | |
|---|---|---|
| Body No. | Dk/Df @28 GHz | R.C. % |
| 6 | 0.001953 | 58% |
| 14 | 2.8/0.002163 | 53% |
| 15 | 2.9092/0.001928 | 56% |
| 16 | 2.84/0.001727 | 63% |
| 17 | Not measured/0.002374 | 51% |
| 18 | Not measured/0.00329 | 67% |

100 parts by weight of each of hydrocarbon resin polymers 1 to 18 were individually mixed with 100 parts by weight of toluene, 15 parts by weight of a toughening agent, 9 parts by weight of divinylbenzene (DVB), 0.27 parts by weight of a peroxide, and 30 parts by weight of a filler. The mixture was then milled using zirconia beads until the filler was uniformly dispersed to prepare resin solutions 1 to 18. The toughening agent was Ricon 100; the filler was either SVC purchased from Admatch or SS-10 purchased from Tokuyama. The peroxide may be 1,4-Di-(2-tert-butylperoxyisopropyl)benzene (Perbutyl P), purchased from Nippon Oil Corporation.

Glass fiber cloth (Asahi 2116, Dk/Df=3.3/0.0030 at 28 GHz) was individually impregnated with resin solutions 1 to 18 and then baked at 130 °C for 7 minutes to obtain prepregs 1 to 18. Two prepregs were stacked with copper foil (RTF, Hoz, 18 m, Rz: 3.5 m), and a silane adhesive (KBM503) was applied between the copper foil and the prepregs. The stack was then pressed at 210 °C for 3 hours to obtain substrate samples 1 to 18. The following properties of substrate samples 1 to 18 were subsequently measured.

### Measurement of Electrical Properties

The dielectric constant and loss tangent (Dk/Df) and R.C.% of substrate samples 1 to 18 at 10 GHz were measured using network analyzer software (Network Analyzer Keysight, P5007A, SCR). The measurement results are shown in Table 5.

### Measurement of Glass Transition Temperature (Tg)

Substrate samples 1 to 18 were heated from 25 °C to 270 °C at a rate of 3 °C/min. The glass transition temperature (Tg) of cured resin bodies 1 to 18 was measured using dynamic mechanical analysis (DMA, TA/Q800) at a test frequency of 1 Hz. The glass transition temperature (Tg) of cured resin bodies 1 to 18 was obtained from the peak of tan delta in the DMA curve. The measurement results are shown in Table 5.

### Peeling Strength Test

The peeling strength of substrate samples 1 to 18 (dimensions: 12.7 mm×20 mm) was measured using a universal testing machine (SHIMADZU AG-Xplus) at a peel rate of 50.8 mm/min in the vertical direction (90°). The measurement results are shown in Table 5.

### Measurement of Percent of Thermal Expansion (PTE)

Thermomechanical analysis (TMA, Q400, TA) was used to analyze the thermal expansion of substrate samples 1 to 18 using the following procedure.

Cycle 1 to Cycle 4 were sequentially performed, with Cycle 3 as the measurement reference. Dimensions at different temperatures (50 and 260 °C) were recorded to calculate the percentage of dimensional change. Cycle 1: under an N₂ atmosphere, equilibrated at 25 °C, held for 1 minute, and heated from 25 °C to 270 °C at 20 °C/min. Cycle 2: cooled from 270 °C to 25 °C at 20 °C/min, held for 1 minute, and equilibrated at 25 °C Cycle 3: heated from 25 °C to 270 °C at 10 °C/min. Cycle 4: cooled from 270 °C to 25 °C at 20 °C/min. The measurement results are listed in Table 5 below.

TABLE 5

| | Hydrocarbon Resin Polymer | | | | | |
|---|---|---|---|---|---|---|
| | 1 | 2 | 3 | 4 | 5 | 6 |
| Dk/Df @10 GHz | 2.77/0.001942 | 2.91/0.001902 | 3.06/0.001904 | 2.87/0.001860 | 2.82/0.001814 | 2.59/0.001509 |
| R.C. % | 69% | 65% | 64% | 69% | 68% | 71% |
| T_{g} (°C) | 206.53 | 197.72 | 194.49 | 194.34 | 196.62 | 190 |
| Peeling Strength | 1.983925 | 2.44 | 2.58 | 2.49 | 2.38 | 2.35 |
| (lb/in) | | | | | | |
| Coefficient of | 1.92 | 3.37 | 3.18 | 3.21 | 2.53 | 3.59 |
| Thermal Expansion | | | | | | |
| @ 50-260 (%) | | | | | | |
| | Hydrocarbon Resin Polymer | | | | | |
| | 7 | 8 | 9 | 10 | 11 | 12 |
| Dk/Df @10 GHz | 2.74/0.001748 | 3.07/0.002101 | 2.72/0.001855 | 2.73/0.001734 | 2.93/0.001886 | 3.06/0.001901 |
| R.C. % | 69% | 45% | 64% | 62% | 67% | 59% |
| T_{g} (°C) | 231 | Not | 170.47 | 165.82 | 179.34 | 161.66 |
| | | measurable | | | | |
| Peeling Strength | 1.95 | 0.06 | 2.41 | 0.32 | 1.61 | 0.9 |
| (lb/in) | | | | | | |
| Coefficient of | 2.1 | Not | 3.52 | 3.71 | 4.21 | 3.7 |
| Thermal Expansion | | measurable | | | | |
| @ 50-260 (%) | | | | | | |

Hydrocarbon Resin Polymer

| | 13 | 14 | 15 | 16 | 17 | 18 |
|---|---|---|---|---|---|---|
| Dk/Df @10 GHz | 3.14/0.002262 | 3.8/0.002067 | 2.72/0.001851 | 2.91/0.001954 | 2.879/0.001982 | 3.106/0.002886 |
| R.C. % | 53% | 60% | 66% | 67% | 69% | 55% |
| T_{g} (°C) | 225 | 211 | 214.28 | 218.01 | 221.96 | 167.47 |
| Peeling Strength | 2.1 | 0.5 | 1.4 | 1.0 | 1.85 | 0.6 |
| (lb/in) | | | | | | |
| Coefficient of | 4.7 | 0.25 | 0.4 | 0.43 | 1.877 | 1.15 |
| Thermal Expansion | | | | | | |
| @ 50-260 (%) | | | | | | |

As shown in Table 5, the substrate samples 1 to 7, 9 to 13, and 15 to 18 of the present disclosure have glass transition temperatures (Tg) greater than 146 °C. The substrate samples 1 to 7, 13, and 15 to 17 have glass transition temperatures greater than 190 °C. The substrate samples 1, 7, 13, and 15 to 17 even exhibit glass transition temperatures greater than 200 °C.

The hydrocarbon resins of the present disclosure, whether formed into cured resin bodies or substrate samples, exhibit excellent dielectric properties.

In addition, as shown in Table 5, the peeling strength of substrate samples 2 to 6 and 9 is greater than 2.2 lb/in, indicating that the hydrocarbon resins of the present disclosure have excellent interfacial adhesion and can form cured resin bodies having high peeling strength. The thermal expansion coefficients of substrate samples 15, 16, and 18 are less than 1.2%, demonstrating excellent thermal expansion performance and good adhesive reliability under thermal stress conditions.

It is clear that in addition to excellent electrical properties and thermal performance, the hydrocarbon resins of the present disclosure also have outstanding solubility, with a solubility in toluene greater than 50 wt %. The hydrocarbon resins of the present disclosure further show good processability. Resin compositions including the hydrocarbon resins of the present disclosure can form cured resin bodies having high peeling strength, while resin products including such cured resin bodies can simultaneously exhibit excellent electrical properties, thermal performance, and reliability. Furthermore, the present disclosure can reduce the temperatures used in high-temperature manufacturing of substrates and/or cured resin bodies, thereby lowering the risk of thermal oxidation of the hydrocarbon resin, reducing char formation, and/or decreasing overall energy consumption. In some embodiments, the present disclosure can improve polymer performance (e.g., providing higher glass transition temperatures, better thermal expansion coefficients, and higher peeling strength) by replacing DCPD or CPD with low-toxicity chemicals such as indene. In some embodiments, the hydrocarbon resin polymers of the present disclosure can be purified using a water-based extraction process and solvents can be recovered, further reducing the use of organic solvents while maintaining both performance and environmental sustainability.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A hydrocarbon resin polymer, comprising:
a structural unit (A) represented by the following Chemical Formula (I); and
a structural unit (B) derived from a divinyl aromatic compound, 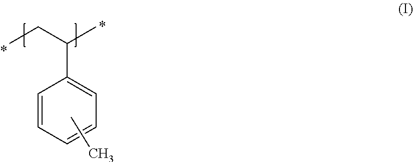
wherein “*” indicates a bonding site at which the structural unit (A) is connected to another group or unit.

2. The hydrocarbon resin polymer as claimed in claim 1, wherein based on 100 mol % of the total structural units in the hydrocarbon resin polymer, a content of the structural unit (A) is 10 to 50 mol %.

3. The hydrocarbon resin as claimed in claim 1, wherein based on 100 mol % of the total structural units in the hydrocarbon resin polymer, a content of the structural unit (B) is 15 to 45 mol %.

4. The hydrocarbon resin as claimed in claim 1, wherein the structural unit (B) comprises a crosslinkable structural unit (B1) and a crosslinked structural unit (B2): 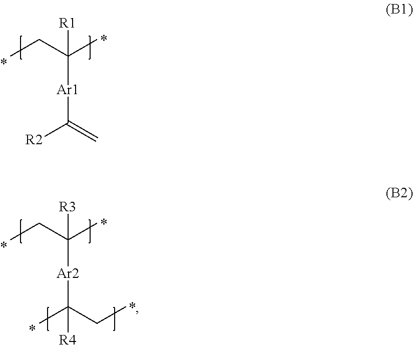
wherein R1, R2, R3, and R4 are each independently H or a C₁₋₂₀ alkyl group;
Ar1 and Ar2 are each a divalent group having a carbocyclic aromatic structure; and
“*” represents a bonding site at which the crosslinkable structural unit (B1) and the crosslinked structural unit (B2) are connected to another group or unit.

5. The hydrocarbon resin as claimed in claim 4, wherein based on 100 mol % of the total structural units in the hydrocarbon resin polymer, a content of the crosslinkable structural unit (B1) is 10 to 40 mol %.

6. The hydrocarbon resin as claimed in claim 1, wherein the hydrocarbon resin polymer has a cross-linking degree of 0.01 to 0.5.

7. The hydrocarbon resin as claimed in claim 1, further comprising a structural unit (C) derived from a polycyclic aromatic compound.

8. The hydrocarbon resin as claimed in claim 7, wherein based on 100 mol % of the total structural units in the hydrocarbon resin polymer, a content of the structural unit (C) is 20 to 60 mol %.

9. The hydrocarbon resin as claimed in claim 7, wherein based on 100 mol % of the total structural units in the hydrocarbon resin polymer, a sum of the contents of the structural unit (B) and the structural unit (C) are 50 to 80 mol %.

10. The hydrocarbon resin as claimed in claim 1, wherein a hydrogen content on the reactive double bonds of the hydrocarbon resin polymer is 2 to 10%.

11. The hydrocarbon resin as claimed in claim 1, wherein the hydrocarbon resin polymer has a PL of 400 to 7,000,
wherein PL is calculated using the following equation:
PL=Mn*PDI*H/100,
wherein Mn is a number-average molecular weight (Mn) of the hydrocarbon resin polymer;
PDI is a ratio of a weight-average molecular weight (Mw) to the number-average molecular weight (Mn);
H is a numerical value expressed as H %, used directly in the calculation without converting the percentage; and
H % is a hydrogen atom content on reactive double bonds of the hydrocarbon resin polymer.

12. The hydrocarbon resin polymer as claimed in claim 11, wherein the hydrocarbon resin polymer has a PL of 1,000 to 6,400.

13. The hydrocarbon resin polymer as claimed in claim 1, wherein the hydrocarbon resin polymer has a polymer dispersity index (PDI) of <16, and the PDI is the ratio of the weight-average molecular weight (Mw) to the number-average molecular weight (Mn) of the hydrocarbon resin polymer.

14. The hydrocarbon resin polymer as claimed in claim 1, wherein the hydrocarbon resin polymer has a number-average molecular weight (Mn) of 5,000 to 20,000 g/mol.

15. The hydrocarbon resin polymer as claimed in claim 1, wherein the hydrocarbon resin polymer has an Fp of 0.05 to 1.0,
wherein Fp is calculated using the following equation:
Fp=1/PDI,
wherein PDI is a ratio of the weight-average molecular weight (Mw) to the number-average molecular weight (Mn) of the hydrocarbon resin polymer.

16. The hydrocarbon resin polymer as claimed in claim 1, wherein the hydrocarbon resin polymer does not comprise structural units derived from dicyclopentadiene (DCPD) or cyclopentadiene (CPD).

17. The hydrocarbon resin polymer as claimed in claim 1, wherein the hydrocarbon resin polymer has a PL/Fp of 4,000 to 100,000,
wherein PL is calculated using the following equation:
PL=Mn*PDI*H/100,
wherein Fp is calculated using the following equation:
Fp=1/PDI,
wherein Mn is the number-average molecular weight (Mn) of the hydrocarbon resin polymer;
PDI is the ratio of the weight-average molecular weight (Mw) to the number-average molecular weight (Mn);
H is a numerical value expressed as H %, used directly in the calculation without converting the percentage; and
H % is a hydrogen atom content on reactive double bonds of the hydrocarbon resin polymer.

18. The hydrocarbon resin as claimed in claim 1, further comprising a structural unit (D) derived from a monovinyl aromatic compound, wherein the structural unit (D) is different from the structural unit (A).

19. The hydrocarbon resin as claimed in claim 18, wherein based on 100 mol % of the total structural units in the hydrocarbon resin polymer, a content of the structural unit (D) is 0.1 to 30 mol %.

20. A method for manufacturing a hydrocarbon resin polymer, comprising:
performing a polymerization process to form a reaction product including the hydrocarbon resin polymer as claimed in claim 1 from a mixture,
wherein the mixture comprises:
a divinyl aromatic compound; and
vinyl toluene.

21. The method for manufacturing a hydrocarbon resin polymer as claimed in claim 20, further comprising performing a purification process on the reaction product, wherein the purification process uses water.

22. A resin composition, comprising the hydrocarbon resin polymer as claimed in claim 1.

23. A curable composite material, comprising the hydrocarbon resin polymer as claimed in claim 1.

24. A cured resin body, which is formed from the hydrocarbon resin polymer as claimed in claim 1.

25. A resin product, comprising the cured resin body as claimed in claim 24.
